(19) United States
(12) Patent Application Publication
(10) Pub. No.: US 2008/0303360 A1
(43) Pub. Date: Dec. 11, 2008

(54) INSULATED BEARING MOTOR ASSEMBLY

(75) Inventors: Wade D. Vinson, Magnolia, TX (US); John P. Franz, Houston, TX (US); George A. Ozuna, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY L.P., Houston, TX (US)

(21) Appl. No.: 12/100,300

(22) Filed: Apr. 9, 2008

Related U.S. Application Data
(60) Provisional application No. 60/943,195, filed on Jun. 11, 2007.

(51) Int. Cl. H02K 5/15; H02K 5/20

(52) U.S. Cl. 310/59; 310/90; 310/89

(57) ABSTRACT

A motor with improved bearing life has a shaft rotatably supported by a pair bearings. The motor further has a stator and a rotor, wherein one of the stator and the rotor is mounted to the shaft and the other of the stator and the rotor surrounds the shaft so that the stator and rotor can rotate with respect to one another. The motor has one or more features to protect at least one of the bearings from heat emitted by at least one of the stator and the rotor.

### CROSS-REFERENCE TO RELATED APPLICATIONS

This application claims priority of U.S. Provisional Application No. 60/943,195, filed Jun. 11, 2007, entitled “Insulated Bearing Motor Assembly.”

### BACKGROUND

Fans powered by electric motors are commonly used to cool computer servers and other electronic equipment. Overheating of bearings in such motors is a common cause of failure of the bearings. Typically, fan motors operate at relatively high rotational speeds, often in excess of 10,000 revolutions per minute. In general, provided the bearings are properly sized and assembled for the fan motor application, high temperature operation can accelerate a breakdown in bearing lubrication, which in turn results in material flaking from the bearing components, and ultimately failure of the bearings.

Bearings are heated by at least two sources. First, electric motors generate heat during operation as a result of both electrical and mechanical inefficiencies. This heat emanates from motor windings and is transmitted to the bearings by radiation and convection, as heat is radiated or convectively carried by air flow directly from the windings to the bearings, and by conduction, as heat is conducted through the motor housing from the magnets and/or windings to the bearings. Second, the rotating elements in the bearings themselves generate frictional heat.

In typical computing systems, including computer servers, more efficient cooling can be achieved by exhausting air out of an enclosure than by blowing air into the enclosure. Accordingly, fans are generally configured so that air is drawn by the fan across the electric motor as it is exhausted from the computer system. This configuration exposes the fan motor to warm air being removed from the computer system. In addition, the downstream or exhaust-side bearing is further exposed to air that has been warmed by the motor itself.

Bearing life is usually specified in the industry as “fatigue life.” Fatigue life, represented symbolically by L₁₀, is a standard measure in the industry to determine the useful lifespan of bearings. Fatigue life is defined as the expected life that would be achieved by 90% of similar bearings operating under similar conditions. Fatigue life is calculated by a formula including such factors as the speed, loading, and temperatures under which the bearings are operating, and takes into account material composition and surface condition of the bearings. In particular, a direct relationship can be established between bearing operating temperature and bearing fatigue life.

### BRIEF DESCRIPTION OF THE DRAWINGS

The accompanying drawings illustrate embodiments of an insulated motor bearing assembly described herein.

In the drawings:

FIG. 1 is a cross-sectional view of a prior art motor.

FIG. 2 is a cross-sectional view of an embodiment of the motor having an insulated bearing assembly.

FIG. 3 is a cross-sectional view of an embodiment of the motor having an insulated bearing assembly.

FIG. 4 is a cross-sectional view of an embodiment of the motor having an insulated bearing assembly.

FIG. 5 is a cross-sectional view of an embodiment of the motor having an insulated bearing assembly.

FIG. 6 is a cross-sectional view of an embodiment of the motor having an insulated bearing assembly.

### DETAILED DESCRIPTION

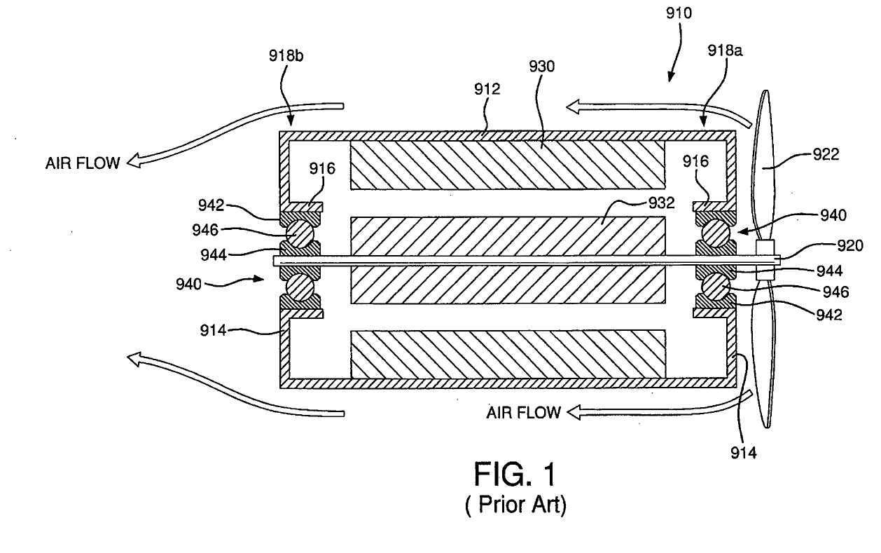

There is shown in FIG. 1 a prior art fan motor 910 comprising a housing 912 having opposed ends 914, with one end 914 located at an inlet portion 918a of the motor 910 and another end 914 located at an exhaust portion 918b of the motor 910. A stator 930 comprising stator magnets is disposed inside the housing 912 and is mounted thereto. The stator magnets are electromagnets comprising windings. A rotor 932 comprising rotor magnets is disposed on and mounted to a shaft 920 extending through the housing 912. The rotor magnets can be permanent magnets or electromagnets comprising windings. In a brushless motor, the rotor 932 comprises permanent magnets while the stator 930 comprises electromagnetic windings. In a motor with brushes, both the rotor 932 and stator 930 may comprise electromagnetic windings.

The shaft 920 is rotatably supported by a pair of bearings 940 mounted in bearing mounts 916 disposed in either end 914 of the housing 912. Each bearing 940 comprises an outer race 942, an inner race 944, and rollers 946. A fan blade 922 is mounted to the shaft 920 at the inlet portion 918a of the motor 910 and draws air flow across the motor 910 to the exhaust portion 918b. The housing 912, including with the ends 914, fully encloses the stator 930 and rotor 932 so that the air flow does not circulate between the outside and the inside of the housing 912. Moreover, the bearing mounts 916 extend inwardly from the housing ends 914 such that the bearings 940 are disposed within the housing 912 and are surrounded on all sides but one by the interior of the motor 910.

Alternatively, although not illustrated, the shaft 920 can be rotatably supported wherein both bearings 940 are disposed at one end 914 of the housing 912 with the motor 910 disposed within the housing 912 on one side of the bearings 940 and the fan blade 922 disposed on the opposite side of the bearings. The apparatus disclosed herein is equally applicable to a motor 910 having such a bearing configuration.

It is noted that for consistency and ease of explanation, the fan motors described throughout this specification are inner rotor motors. In an inner rotor motor, a shaft-mounted rotor is surrounded by a generally annular stator and the rotor spins along with the shaft while the stator remains stationary. Nevertheless, the features disclosed herein are equally applicable to outer rotor motors. In an outer rotor motor, a shaft-mounted stator remains stationary while a generally annular rotor surrounds the stator and rotates about the stator. The features disclosed herein are applicable to both types of motors. Regardless, all fan motors have rotor magnets and stator magnets such that the rotor rotates relative to the stator, whether in an inner rotor motor wherein the rotor rotates with the housing while the shaft-mounted stator is stationary, or in an outer rotor motor, wherein the rotor rotates with the shaft while the housing-mounted stator is stationary. Bearings disposed between the shaft and the housing accommodate this relative rotation.

The bearings 940 are in close proximity to the stator 930 and rotor 932, and are attached to thermally conductive materials with minimal exposure to external air movement. Typically, the housing 910 is made from steel or back iron for proper magnetic interaction with the stator windings 930. The stator windings 930 (and rotor windings 932, in the case of an electromagnetic rotor), generate heat due to resistive losses in the windings. The steel or iron of the housing 910 has a high thermal conductivity and therefore readily conducts heat away from the stator 930 to cooler parts of the motor 910 such as the bearing mounts 916. The shaft 920 is typically made from steel, and is sometimes made from stainless steel. The steel or stainless steel of the shaft 920 has a high thermal conductivity and therefore readily conducts heat along its length from the rotor 932 to cooler parts of the motor 910 such as the inner races 944 of the bearings 940.

A typical fan motor for use in computer systems drives a fan having a diameter of approximately 120 millimeters. Such fans commonly experience a 35° C. air temperature rise from the end 914 at the inlet portion 918a to the end 914 at the exhaust portion 918b, as air warmed by the computer system and the stator 930 and the rotor 932 heats the exhaust portion 918b more than the inlet portion 918a. Consequently, the bearing 940 mounted to the end 914 at the exhaust portion 918b is heated more than the bearing 940 mounted to the end 914 at the inlet portion 918a.

Servers typically are rated to operate about 35° C., so that air drawn into the fan 922 can be expected to be at that temperature. Accordingly, with a 35° C. temperature rise, the exhaust-end bearing 914 will reach a temperature of about 70° C. This 70° C. temperature is enough to cause the heat related damage, thus reducing the life of the bearings 914.

For a 120 millimeter fan motor, bearing fatigue life can be computed by the following equation. The equation coefficients can be adjusted empirically to account for different sizes of motors and bearings, and for different material compositions and types of bearings.

$$Log ( L ) = 8.08 - 0.75 n / N - ( 0.027 - 0.001 n / N ) * T - ( 0.21 * T * n / N + 0.03 T + 20.5 ) * {( \frac{P}{{C}_{r}} )}^{2}$$

Where:
n=rotational speed [revolutions per minute]
N=maximum rotational speed [revolutions per minute]
T=bearing temperature measured out the outer race [° C.]
P=equivalent load [kilograms-force]
Cᵣ=basic dynamic load rating of radial bearings [kilograms-force]

The effect of temperature can be illustrated by a typical example, where the motor is operating at 40% of its maximum speed (n/N=0.4) and the bearings are operating at 10% of their rated loading (P/Cr=0.1). In that case, a bearing operating at 60° C. will have a fatigue life of about 814,000 hours, while a bearing operating at 70° C. will have a fatigue life of about 430,000 (a reduction of 47% from 60° C. operation) and a bearing operating at 80° C. will have a fatigue life of about 227,000 hours (a reduction of about 72% from 60° C. operation). While the bearing life can be extended by lowering operating speed, decreasing loading, or modifying other factors (such as bearing size, which is captured in the equation coefficients), these factors typically cannot be changed without a negative impact on cost or performance.

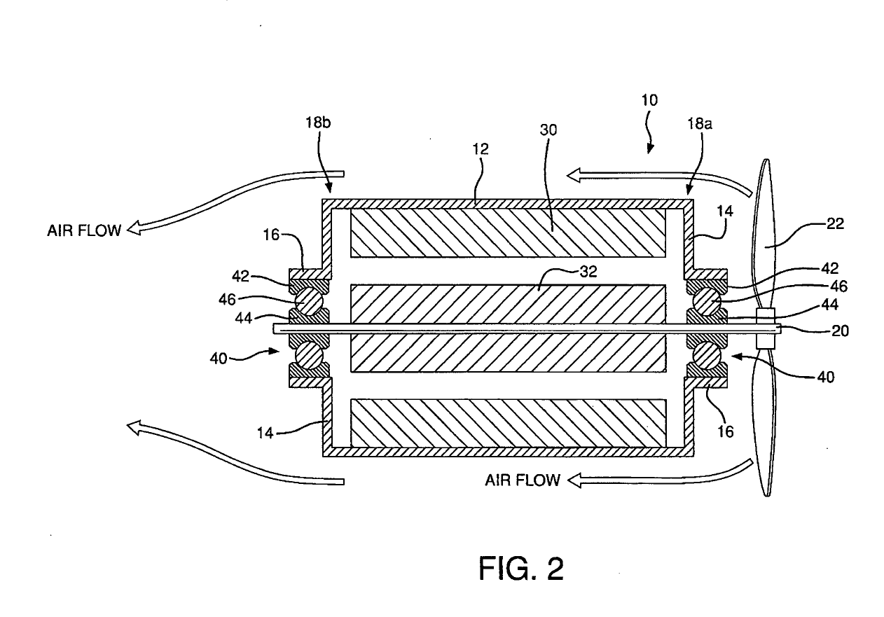

One embodiment of an improved fan motor 10 is shown in FIG. 2. The motor 10 comprises a housing 12 having opposed ends 14, with one end 14 located at an inlet portion 18a of the motor 10 and another end 14 located at an exhaust portion 18b of the motor 10. A stator 30 comprising stator magnets formed from electromagnetic windings is disposed inside the housing 12 and is mounted thereto. A rotor 32 comprising rotor magnets is disposed on and mounted to a shaft 20 extending through the housing 12, the rotor magnets 32 being either permanent magnets or electromagnetic windings. The shaft 20 is rotatably supported by a pair of bearings 40 mounted in bearing mounts 16 disposed in either end 14 of the housing 12. Each bearing 40 comprises an outer race 42, an inner race 44, and rollers 46. A fan blade 22 is mounted to the shaft 20 at the inlet portion 18a of the motor 10 and draws air flow across the motor 10. The bearing mounts 16 can be constructed separately from the housing 10 or can be integrally formed as part of the housing 10. The bearing mounts 16 can be constructed from a wide array of materials, including but not limited to plastic, stamped steel, and die cast or machined metals such as aluminum, zinc, and magnesium.

The bearing mounts 16 of the motor 10 extend outwardly from the ends 14 of the housing 12, such that the bearings 40 are surrounded an all sides but one by ambient air, and are exposed only on one side to the interior of the motor 10. This arrangement significant reduces the exposure of the bearings 40 to the heat generated by the stator windings 30 (and rotor windings 32, if applicable) and provides greater surface area through which the bearings 40 can dissipate heat. Accordingly, by reducing heat transfer to the bearings 40 from the motor 10 and increasing heat transfer from the bearings 40 to the surrounding ambient, bearing temperatures can be reduced, particularly at the exhaust portion 18b of the motor 10.

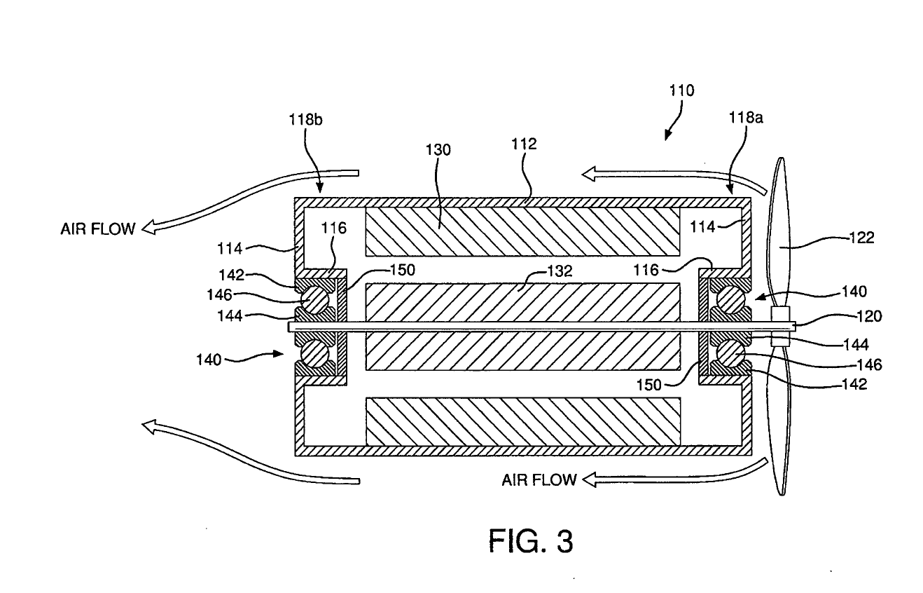

Another embodiment of an improved fan motor 110 is shown in FIG. 3. The motor 110 comprises a housing 112 having opposed ends 114, with one end 114 located at an inlet portion 118a of the motor 110 and another end 114 located at an exhaust portion 1 18b of the motor 110. A stator 130 comprising stator magnets formed from electromagnetic windings is disposed inside the housing 112 and is mounted thereto. A rotor 132 comprising rotor magnets is disposed on and mounted to a shaft 120 extending through the housing 112, the rotor magnets being either permanent magnets or electromagnetic windings. The shaft 120 is supported by a pair of bearings 140 mounted in bearing mounts 116 disposed in either end 114 of the housing 112. Each bearing 140 comprises an outer race 142, an inner race 144, and rollers 146. A fan blade 122 is mounted to the shaft 120 at the inlet portion 118a of the motor 110 and draws air flow across the motor 110.

Each bearing mount 116 comprises a thermal shield 150 for isolating or protecting the respective bearings 140 from heat emitted by the stator windings 130 (and rotor windings 132, if applicable). The thermal shields 150 block heat radiated by the stator 130 and the rotor 132 from reaching the bearings 140. The thermal shields 150 further block heat that would otherwise be conveyed convectively from the stator 130 and rotor 132 to the bearings 140 by air currents circulating within the housing 112, by preventing the bearings 140 from being exposed to those air currents. The shield 150 can be made from any solid insulating material including but not limited to plastic. The shield 150 is depicted in FIG. 3 as being of similar diameter to the bearing 140; however, the shield 150 can have a diameter larger than the bearing 140 and in one embodiment the shield 150 extends to the inside wall of the housing 112. Additionally, the shield 150 can be flat, as depicted, or can be contoured, for example, to match the surfaces that make up the bearings 140, the mounts 116, and the housing ends 114. The thickness of the shield 150 can depend on several factors, including the space available and the insulation required. In one embodiment, an injection-molded plastic shield 150 is about 2 millimeters thick, which provides for sufficient rigidity and insulation. Isolating the bearings 140 from radiation and convention of heat emitted by the stator 130 and rotor 132 significantly reduces the heat transfer to the bearings 40, thus reducing the temperature of the bearings 140.

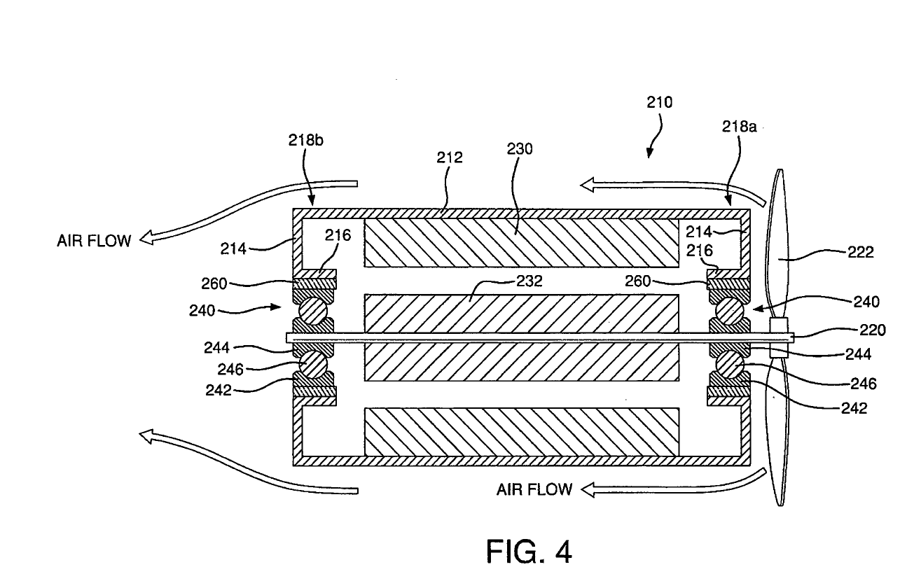

Another embodiment of an improved fan motor 210 is shown in FIG. 4. The motor 210 comprises a housing 212 having opposed ends 214, with one end 124 located at an inlet portion 218a of the motor 210 and another end 214 located at an exhaust portion 218b of the motor 210. A stator 230 comprising stator magnets is disposed inside the housing 212 and is mounted thereto. A rotor 232 comprising rotor magnets is disposed on and mounted to a shaft 220 extending through the housing 212, the rotor magnets 232 being either permanent magnets or electromagnetic windings. The shaft 220 is supported by a pair of bearings 240 mounted in bearing mounts 216 disposed in either end 214 of the housing 212. Each bearing 240 comprises an outer race 242, an inner race 244, and rollers 246. A fan blade 222 is mounted to the shaft 220 at the inlet portion 218a of the motor 210 and draws air flow across the motor 210.

The motor 210 comprises an annular insulating sleeve 260 disposed between each bearing mount 216 and the outer race 242 of its respective bearing 240. The insulating sleeves 260 protect the bearings 240 from heat emitted by the stator windings 230 (and rotor windings 232, if applicable) and conducted by the motor housing 212 to the bearing mounts 216. The motor housing 212 can be made from a variety of materials such as metal or plastic. Particularly when the housing 212 is constructed of a metal having a high thermal conductivity, such as aluminum, the housing 212 can transmit heat effectively from the stator 230 and the rotor 232 to the bearing mounts 216. The insulating sleeves 260 are made from a material having a lower thermal conductivity (and preferably a much lower thermal conductivity) than the material from which the housing 212, the ends 214, and the bearing mounts 216 are constructed. For example, the insulating sleeves 260 can be made from ceramic or plastic or other thermal insulating material. The material of the insulating sleeve 260 should be capable of maintaining tight tolerances, handling bearing loads, and insulating against conductive heat transfer. Dimensionally, the insulating sleeve 260 matches the outer diameter of the outer race 242 of the bearing 240. The thickness of the insulating sleeve 260 can be adjusted as required for strength and heat transfer characteristics. In one embodiment, a ceramic insulating sleeve 260 is about 1 millimeter thick. Therefore, the insulating sleeves 260 prevent conducted heat from reaching the bearings 240, thus significantly reducing the temperature of the bearings 240.

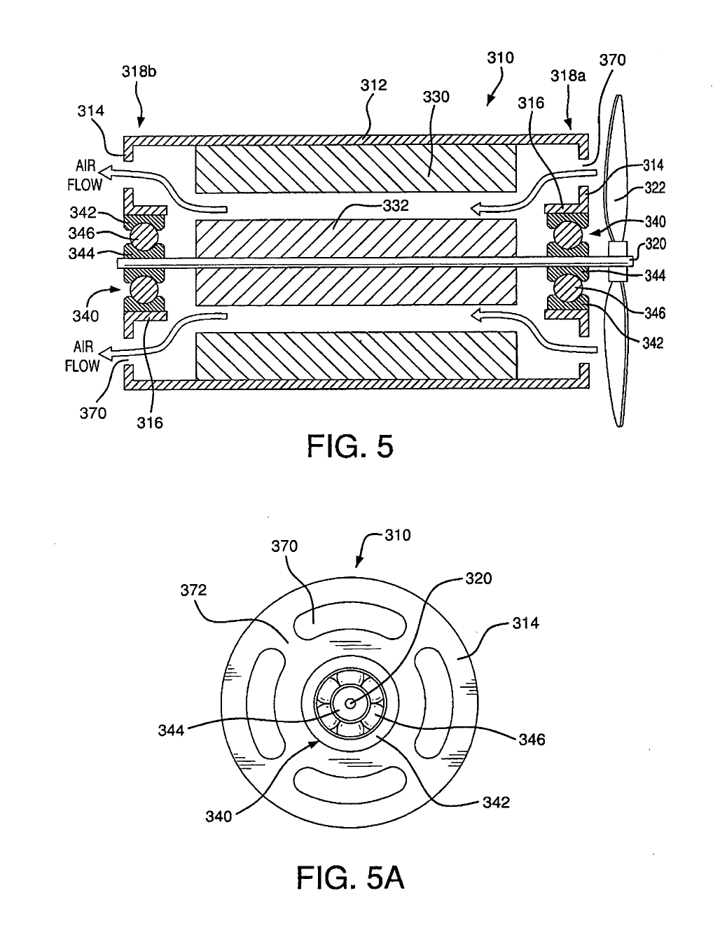

Another embodiment of an improved fan motor 310 is shown in FIG. 5. The motor 310 comprises a housing 312 having opposed ends 314, with one end 314 located at an inlet portion 318a of the motor 310 and another end 314 located at an exhaust portion 318b of the motor 310. A stator 330 comprising stator magnets formed from electromagnetic windings is disposed inside the housing 312 and is mounted thereto. A rotor 332 comprising rotor magnets 332 is disposed on and mounted to a shaft 320 extending through the housing 312, the rotor magnets being either permanent magnets or electromagnetic windings. The shaft 320 is supported by a pair of bearings 340 mounted in bearing mounts 316 disposed in either end 314 of the housing 312. Each bearing 340 comprises an outer race 342, an inner race 344, and rollers 346. A fan blade 322 is mounted to the shaft 320 at the inlet portion 318a of the motor 310 and draws air flow across the motor 310.

The motor 310 is not fully enclosed. The ends 314 each comprise openings 370 interposed between supports 372 such that air flow created by the fan 322 can be used to cool the internal components of the motor 310. Air flow created by the fan 322 enters the housing 312 through the openings 370 in the end 14 at the inlet portion 31 Ba, flows across and cools the stator 330 and rotor 332, and exits the housing 312 through the openings 370 in the end 314 at the exhaust portion 318b. By conveying heat away from the stator 330 and rotor 332, the air flow removes heat that could otherwise be conveyed to the bearings 340. In addition, as shown in FIG. 5A, the openings 370 in the ends 314 leave relatively small pathways, by way of the supports 372, for heat to be conducted from the housing 312 to the bearing mounts 316. Reducing the conduction pathway further decreases the heat that can be conducted to the bearings 340. As a result, the temperature of the bearings 340 is significantly reduced. The ratio of open area created by the openings 370 to closed area where the supports 372 remain is preferably in the range of about 30% to about 50%, depending on whether the openings 370 are holes or slots and on the orientation and location of the openings 370. In one embodiment, an open area ratio of about one-third provides for effective air flow through the motor 310.

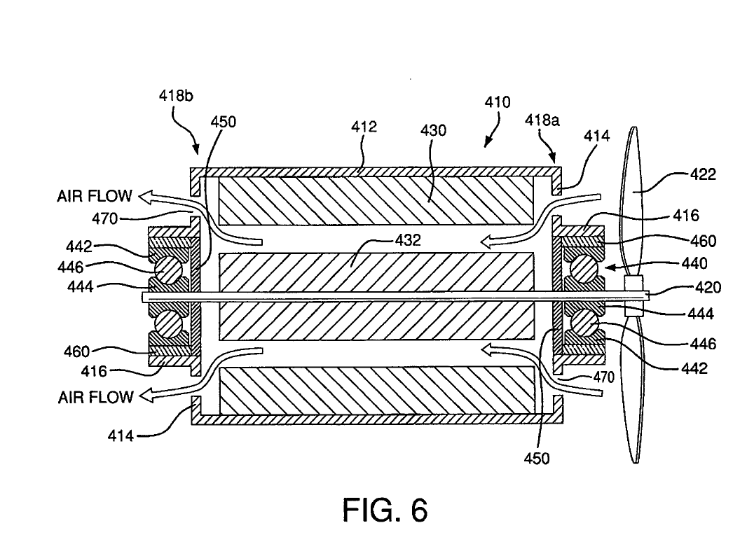

Another embodiment of an improved fan motor 410 is shown in FIG. 6. The motor 410 comprises a housing 412 having opposed ends 414, with one end 414 located at an inlet portion 418a of the motor 410 and another end 414 located at an exhaust portion 418b of the motor 410. A stator 430 comprising stator magnets formed from stator windings is disposed inside the housing 412 and is mounted thereto. A rotor 432 comprising rotor magnets is disposed on and mounted to a shaft 420 extending through the housing 412, the rotor magnets 432 being either permanent magnets or electromagnetic windings. The shaft 420 is supported by a pair of bearings 440 mounted in bearing mounts 416 disposed in either end 414 of the housing 412. Each bearing 440 comprises an outer race 442, an inner race 444, and rollers 446. A fan blade 422 is mounted to the shaft 420 at the inlet portion 418a of the motor 410 and draws air flow across the motor 410.

The motor 410 incorporates several features to reduce the operating temperature of the bearings 440. First, the bearing mounts 416 extend outwardly from the ends 414 of the housing 412, such that the bearings 440 are surrounded on all sides but one by ambient air, and are exposed only on one side to the interior of the motor 410. Second, each bearing mount 416 comprises a thermal shield 450 for isolating the respective bearings 440 from heat that would otherwise be transferred from the stator 430 and rotor 432 to the bearings 440 by radiation and convection. Third, the motor 410 comprises an annular insulating sleeve 460 disposed between each bearing mount 416 and the outer race 442 of its respective bearing 440, to protect the bearings 440 from heat that would otherwise be conducted from the stator 430 and rotor 432 through the housing 412, the ends 414, and the bearing mounts 416 to the bearings 440. Fourth, the motor 410 is not fully enclosed in the housing 412. The ends 414 each comprise openings 470 interposed between supports 472. The openings allow air flow created by the fan 422 to cool the internal components of the motor 410 and to carry heat away from the bearings 440. The openings 470 further enable a decrease in the heat conducted to the bearing mounts 416 by reducing the width of the conduction pathways 472 between the housing 412 and the bearing mounts 416.

What is claimed is:

1. A motor with improved bearing life, the motor comprising:
a shaft rotatably supported by a pair of bearings;
a stator and a rotor, one of the stator and the rotor being mounted to the shaft and the other of the stator and the rotor surrounding the shaft; and
means for protecting the bearings from heat emitted by at least one of the stator and the rotor.

2. The motor of claim 1, the means for protecting the bearings comprising a housing surrounding the stator and the rotor, wherein at least one bearing is mounted to the housing and is disposed outwardly therefrom.

3. The motor of claim 1, the means for protecting the bearings comprising a thermal shield interposed between at least one of the bearings and the stator and rotor.

4. The motor of claim 1, the means for protecting the bearings comprising an insulating sleeve disposed between at least one of the bearings and a bearing mount to which the at least one of the bearings is mounted.

5. The motor of claim 1, the means for protecting the bearings comprising a housing surrounding the stator and the rotor, the housing having a plurality of openings for enabling air circulation to cool the stator and rotor.

6. The motor of claim 5, wherein at least one of the bearings is mounted to the housing and wherein the plurality of openings decreases the conduction pathway for heat transfer to the at least one of the bearings.

7. A motor with improved bearing life, the motor comprising:
a housing;
a shaft extending through the housing, the shaft being rotatably supported by a pair of bearings mounted to the housing;
a stator and a rotor, one of the stator and the rotor being mounted to the shaft and the other of the stator and the rotor being mounted to the housing surrounding the shaft; and
a thermal isolator for protecting one of the bearings from heat emitted by at least one of the stator and the rotor.

8. The motor of claim 7, wherein the thermal isolator shields the bearing from radiative heat transfer.

9. The motor of claim 7, wherein the thermal isolator shields the bearing from convective heat transfer.

10. The motor of claim 7, wherein the thermal isolator comprises a shield interposed between the bearing and the stator and rotor.

11. The motor of claim 7, wherein the thermal isolator insulates the bearing from heat conducted by the housing.

12. The motor of claim 7, wherein the thermal isolator comprises an insulating sleeve disposed between the bearing and the housing.

13. The motor of claim 7, wherein at least one of the bearings is disposed outwardly from the housing.

14. The motor of claim 7, further comprising a plurality of openings in the housing for enabling air circulation to cool the stator and rotor.

15. The motor of claim 14, wherein the plurality of openings reduces the conduction pathway for heat transfer from the housing to at least one of the bearings.

16. A motor with improved bearing life, the motor comprising:
a housing;
a shaft extending through the housing, the shaft being rotatably supported by a pair of bearings mounted to the housing;
a stator and a rotor, one of the stator and the rotor being mounted to the shaft and the other of the stator and the rotor being mounted to the housing surrounding the shaft; and
a plurality of openings in the housing for enabling air circulation to cool the stator and rotor and for reducing the conduction pathway for heat transfer from the housing to at least one of the bearings.

17. The motor of claim 16, wherein at least one of the bearings is disposed outwardly from the housing.

18. The motor of claim 16, further comprising one or more isolators for isolating at least one of the bearings from heat emitted by at least one of the stator and the rotor.

19. The motor of claim 18, wherein the isolator comprises a shield interposed between at least one of the bearings and the stator and rotor.

20. The motor of claim 18, wherein the isolator comprises an insulating sleeve disposed between at least one of the bearings and the housing.
